(19) United States
(12) Patent Application Publication
(10) Pub. No.: US 2009/0063084 A1
(43) Pub. Date: Mar. 5, 2009

(54) Power rail impact analysis system

(76) Inventor: Kevin R. Jensen, Omaha, NE (US)

Correspondence Address: THOMTE LAW OFFICE, L.L.C., 2120 S. 72ND STREET, SUITE 1111, OMAHA, NE, 68124, US

(21) Appl. No.: 12/231,162

(22) Filed: Aug. 29, 2008

Related U.S. Application Data
(60) Provisional application No. 60/967,408, filed on Sep. 4, 2007.

(51) Int. Cl. G06F 19/00

(52) U.S. Cl. 702/115

(57) ABSTRACT

A power rail impact analysis system which provides a total system evaluation of a conductor bar system such as may be used in mass transit, automated people movers, material handling machines, or other mobile electric vehicles. The analysis system of this invention takes samples and records data from the current passing through individual collectors, impacts seen by the collectors, and temperature information of the conductor bar.

### CROSS REFERENCE TO RELATED APPLICATION

This application claims the benefit of the provisional application entitled POWER RAIL IMPACT ANALYSIS SYSTEM, Ser. No. 60/967,408, filed Sep. 4, 2007.

### BACKGROUND OF THE INVENTION

1. Field of the Invention

This invention relates to a means for totally evaluating a power conductor bar system which is sometimes also referred to as a power conductor rail or power rail which is often used in mass transit systems, automated people mover systems, material handling machines, or other mobile electric vehicles which travel upon one or more rails or upon a fixed guideway. More particularly, this invention relates to a total system evaluation of a conductor bar system which supplies electrical power to vehicles or machines traveling upon rails or a fixed guideway.

2. Description of the Related Art

In mass transit systems, automated people mover systems, material handling machines, or other mobile electric vehicles, the vehicles or machines move upon rails and are supplied electrical power through a conductor bar, conductor rail or power rail with those terms being sometimes used interchangeably. Applicants are unaware of any means presently available for evaluating the overall conductor bar system so that individual problem areas may be identified prior to their localized failure which may reduce non-scheduled system downtime. Further, applicants are unaware of any evaluation system which may be used to prioritize maintenance of power rail systems to improve system reliability.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The analysis system of this invention takes samples and records data from the electrical current passing through individual collectors, impacts seen by the collectors, and temperature information of the conductor bar. The information is gathered during normal system operation via sensors mounted to one of the system vehicles. The information is linked to specific locations using a combination of GPS, inertial navigation, and speed sensing. With this location specific system data, the condition of the overall system may be evaluated. Individual problem areas may be identified prior to their localized failure and the information may be used to prioritize maintenance of the system to improve system reliability.

It is therefore a principal object of the invention to provide a power rail impact analysis system.

A further object of the invention is to provide a total system evaluation of a conductor bar system which may be used in mass transit, automated people movers, material handling machines, or other mobile electric vehicles.

Still another object of the invention is to provide a system of the type described which takes samples and records data from the current passing through individual collectors, impacts seen by the collectors, and temperature information of the conductor bar.

Yet another object of the invention is to provide a system which gathers information during normal system operation via sensors mounted to one of the system vehicles.

Still another object of the invention is to provide a system of the type described wherein gathered information is linked to specific locations using a combination of GPS, inertial navigation, and speed sensing.

Still another object of the invention is to provide a system of the type described wherein the condition of the overall system may be evaluated so that individual problem areas may be identified prior to their localized failure which may reduce non-scheduled system downtime.

Yet another object of the invention is to provide a system of the type described wherein the information gathered thereby may be used to prioritize maintenance of the system to improve system reliability.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic of the system.

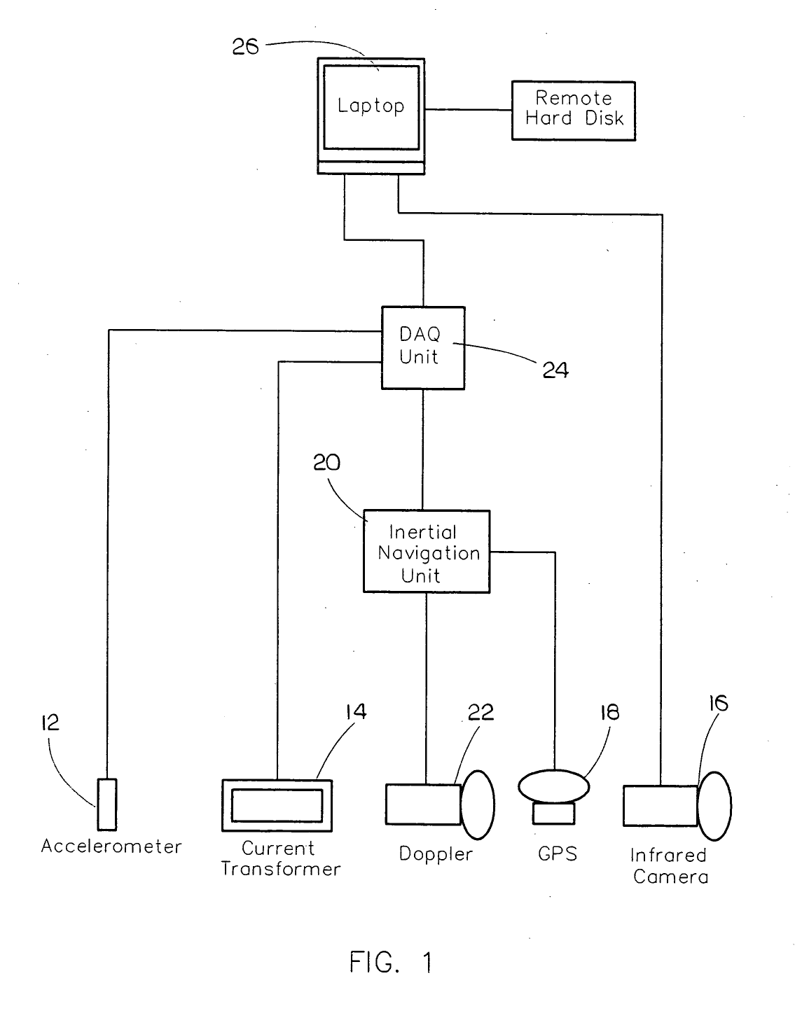

FIG. 2 is a partial perspective view of a vehicle which moves upon rails and which is powered by a power conductor rail and which has the system of this invention associated therewith.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

A plurality of sensors are mounted to one of the system vehicles generally designated by the reference number 10 so that information may be linked to specific locations using a combination of GPS, inertial navigation, and speed sensing. The sensors used include accelerometers 12 mounted on collector 14, one or more current sensors 14, an infrared camera 16, a GPS unit 18, a three-axis inertial navigation unit 20, a Doppler speed sensor 22, a data acquisition system (DAQ) 24, a laptop computer 26, and remote hard drives. All of the equipment is mounted to system vehicle 10, as described hereinbelow.

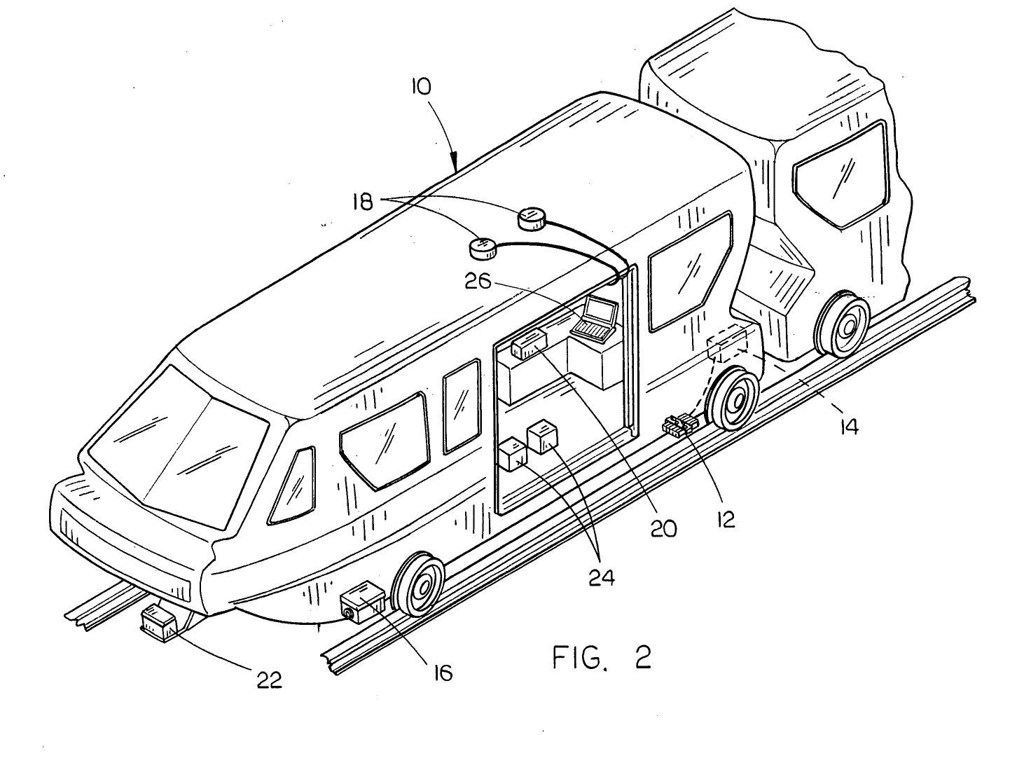

The accelerometers 12 are electrically isolated and are attached to the body of the collectors. The current transformers or sensors 14 are placed around the collector cables. The Doppler speed sensor 22 is mounted to the vehicle to provide a ground speed reference. A GPS antenna is mounted to the outside of the vehicle on the roof thereof. The inertial navigation unit 20, laptop computer 26, DAQ 24, and remote storage disks are mounted inside the vehicle as seen in FIG. 2.

The GPS 18, inertial navigation 20, and Doppler 22 are configured to work as one unit to provide position data. The position data information, accelerometer signals, current transformer signals, and discrete temperature data from the infrared camera are fed into the DAQ 24 for sampling and then sent to the laptop computer 26 to be recorded in a data file for future processing. The video image from the infrared camera 22 is captured onto the remote hard disks.

Unique software has been written to compile the recorded data and video files. The software filters the data based on used input to identify locations of interest. These locations are likely to show events such as elevated temperatures along the conductor bar system, hard impacts seen by the collectors, large current demand through the collectors, large current demand through the collectors for extended distances, or imbalanced loading of the collectors.

The software package brings the position linked data together with the infrared video image for a complete system analysis. Locations that identify elevated conductor bar temperature can be identified via position and time information within the video file. The video images can point to specific conductor components that are the source of the high temperatures. Examples may be loose cable connections, corroded splice joints, etc.

Thus it can be seen that a novel system has been provided to completely evaluate a conductor bar system which may be used in mass transit, automated people movers, material handling machines, or other mobile electric vehicles.

Thus it can be seen that the analysis system of this invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A means for evaluating a power conductor bar system which supplies electrical power to a vehicle or machine traveling upon rails or a fixed guideway; comprising:
a position locator mounted on the vehicle or machine;
an accelerometer mounted on the vehicle or machine;
a current sensor mounted on the vehicle or machine;
an infrared camera mounted on the vehicle or machine;
a data acquisition system mounted on the vehicle which receives data from the position locator, accelerometer, current sensor and infrared camera; and
a computer connected to said data acquisition system for recording in a data file for processing.

2. The means of claim 1 wherein discrete temperature data is supplied from said infrared camera to said data acquisition system.

3. The means of claim 2 wherein the video image from said infrared camera is captured onto remote hard disks.

4. The means of claim 1 wherein said position locator comprises a GPS system.

5. The means of claim 4 wherein said position locator also includes an inertial navigation unit.

6. The means of claim 5 wherein position locator also includes a Doppler speed sensor.

7. A means for evaluating a power conductor bar system which supplies electrical power to a vehicle or machine traveling upon rails or a fixed guideway; comprising:
a position locator mounted on the vehicle or machine;
one or more sensors attached to the vehicle for sensing the condition of the power conductor bar;
a data acquisition system mounted on the vehicle which receives data from the position locator and the one or more sensors; and
a computer connected to said data acquisition system for recording in a data file for processing.

8. The means claim 1 further including a current sensor mounted on the vehicle or machine which supplies data to said data acquisition system.

9. The means of claim 1 further including a current sensor mounted on the vehicle or machine which supplies data to said data acquisition system.

10. The means of claim 1 further including an accelerometer mounted on the vehicle or machine which supplies data to said data acquisition system.

11. The means of claim 7 wherein discrete temperature data is supplied from said infrared camera to said data acquisition system.

12. The means of claim 8 wherein the video image from said infrared camera is captured onto remote hard disks.

13. The means of claim 7 wherein said position locator comprises a GPS system.

14. The means of claim 13 wherein said position locator also includes an inertial navigation unit.

15. the means of claim 14 wherein position locator also includes a Doppler speed sensor.
